(19) United States
(12) Patent Application Publication
(10) Pub. No.: US 2017/0045063 A1
(43) Pub. Date: Feb. 16, 2017

(54) APPARATUS FOR ELIMINATING GAS ACCUMULATION IN PIPE, TANK OR EQUIPMENT

(71) Applicant: Taiki Iba, Tokyo (JP)

(72) Inventor: Taiki Iba, Tokyo (JP)

(21) Appl. No.: 15/125,082

(22) PCT Filed: Mar. 6, 2015
(86) PCT No.: PCT/JP2015/057394

§ 371 Date: Sep. 9, 2016

(30) Foreign Application Priority Data
Mar. 10, 2014 (JP) 2014-064672

(51) Int. Cl. F15D 1/02

(52) U.S. Cl. CPC F15D 1/02

(57) ABSTRACT

[PROBLEM TO BE SOLVED BY THE INVENTION]

In removing gas accumulation in a pipe and/or a tank and an equipment leading to the pipe, the present invention aims to provide an apparatus which does not intake outside air even when inside of the pipe and/or the tank and the equipment leading to the pipe is in a negative pressure condition, and which does not require measures to discharge drainage outside of the system at a time of failure.

[MEANS FOR SOLVING THE PROBLEM]

The present invention prevents gas accumulation by, in a means to deliver gas with liquid in a system, providing a drawing pipe inlet at the top of where gas is accumulated and connecting a drawing pipe led therefrom to an outlet side pipe, and using a means to obtain a delivering pressure having a negative pressure generating head, a valve, a throttle part, a water wheel or a spiral rotation generating part, or a means combining what are listed above, to generate power to deliver gas between a tank as well as an equipment and the outlet side pipe.

### TECHNICAL FIELD

The present invention relates to eliminating gas accumulation during liquid delivery.

### BACKGROUND ART

Conventionally, a float type automatic air vent valve has been used as a method to prevent gas (air) accumulation in a pipe and/or a tank and/or an equipment leading to the pipe. Since the float type automatic air vent valve discharges gas outside of a system, its structure is what may intake air into the system when inside of the system is in a negative pressure condition. In addition, since the float type automatic air vent valve discharges some liquid when discharging air, it was necessary to provide measures to discharge drainage outside of the system (drainpipe) at a time of failure and when wastes are clogged.

However, in the method using the float type automatic air vent valve, there is a sanitary concern for chemicals and/or food etc. which cannot be discharged outside of the system, and in controlling discharging of dangerous liquid, height of the pipe is not varied in a piping layout such that gas is not accumulated, but the piping becomes complicated if the pipe is circumvented for a long distance. In addition, measures to eliminate gas accumulation by performing suction using a pump had to be taken.

### PRIOR ART DOCUMENTS

Patent Document 1: Japanese Laid-Open Patent Publication JP 2001-311526A

Patent Document 2: Japanese Laid-Open Patent Publication JP 2006-266553A

Patent Document 3: Japanese Laid-Open Patent Publication JP H08-210795A

### DISCLOSURE OF THE INVENTION

### Problem to be Solved by the Invention

In removing gas accumulation in a pipe and/or a tank and an equipment leading to the pipe, the present invention aims to provide an apparatus which does not intake outside air even when inside of the pipe and/or the tank and the equipment leading to the pipe is in a negative pressure condition, and which does not require measures to discharge drainage outside of the system at a time of failure.

### Means for Solving the Problem

The present invention prevents gas accumulation by, in a means to deliver gas with liquid in a system, providing a drawing pipe inlet at the top of where gas is accumulated and connecting a drawing pipe led therefrom to an outlet side pipe, and using a means to obtain a delivering pressure having a negative pressure generating head, a valve, a throttle part, a water wheel or a spiral rotation generating part, or a means combining what are listed above, to generate power to deliver gas between a tank as well as an equipment and the outlet side pipe.

### Advantageous Effect of the Invention

A float type automatic air vent valve discharges gas outside of a system, but in the present invention, in a means to deliver gas inside a system in a flowing direction of a liquid inside the same system, by providing a means to generate power to deliver gas between a tank as well as an equipment and an outlet side pipe to deliver gas through a drawing pipe, intake of air from outside of the system is eliminated when inside of the pipe is under negative pressure condition, which results in omission of piping for drainage because of improvement of quality, a decrease in failure rate and unnecessity of measures for drainage to be discharged. In addition, in a circulation circuit, even if there are many places where air is accumulated along the way of the circuit, it is possible to deliver gas with liquid inside a channel to eventually discharge the gas at a single place with a means for discharging gas.

### BRIEF DESCRIPTION OF THE DRAWINGS

FIG. 1 is a drawing in which a drawing pipe inlet at a part of a pipe where air is accumulated, a drawing pipe, and a negative pressure generating head are arranged. (EXAMPLE 1)

FIG. 2 is a drawing in which a drawing pipe inlet at a part of a tank or an equipment where air is accumulated, a drawing pipe, and a negative pressure generating head are arranged. (EXAMPLE 2)

FIG. 3 is a drawing in which a drawing pipe inlet at a part of a tank or an equipment where air is accumulated, a drawing pipe, a negative pressure generating head and a valve are arranged. (EXAMPLE 3)

FIG. 4 is a drawing in which a drawing pipe inlet at a part of a tank or an equipment where air is accumulated, a drawing pipe, a negative pressure generating head, a throttle part and a spiral rotation generating part are arranged.

FIG. 5 is a drawing in which a drawing pipe inlet at a part of a tank or an equipment where air is accumulated, a drawing pipe, a negative pressure generating head and a throttle part are arranged.

FIG. 6 is a drawing in which a drawing pipe inlet at a part of a tank or an equipment where air is accumulated, a drawing pipe, a negative pressure generating head, a valve and a spiral rotation generating part are arranged.

FIG. 7 is a cross section of a part of a tank or an equipment where air is accumulated, wherein A and B are drawings representing a comparison of angle differences, and C is a drawing representing a position of an outlet pipe.

FIG. 8 is a drawing in which a drawing pipe inlet at a part of a pipe where air is accumulated, a drawing pipe, a negative pressure generating head, a water wheel in a spiral rotation generating part and a power generator or a pump are arranged. (EXAMPLE 4)

FIG. 9 is a drawing in which a drawing pipe inlet at a part of a pipe where air is accumulated, a drawing pipe, a water wheel in a spiral rotation generating part and a power generator or a pump are arranged.

### BEST MODE FOR IMPLEMENTING THE INVENTION

In a means to deliver gas, a means to obtain a delivering pressure is used to prevent gas accumulation.

### Example 1

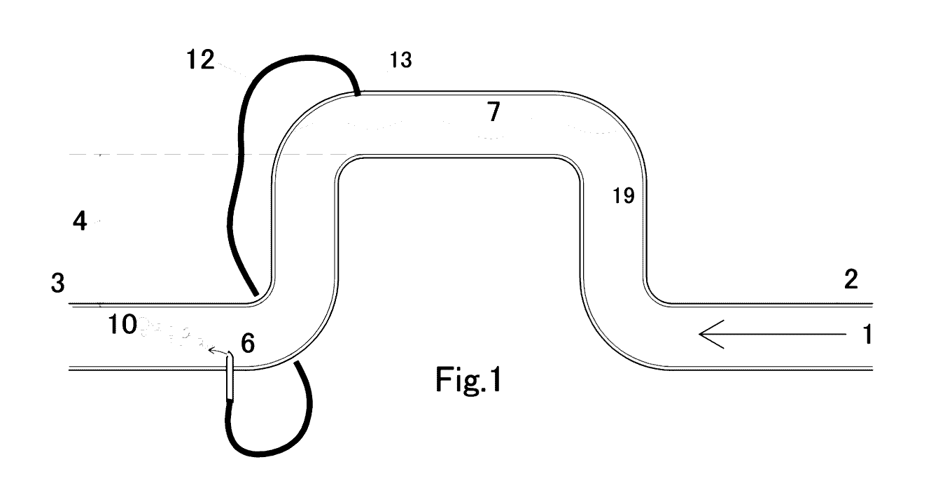

FIG. 1 is a transverse cross-sectional view. When a liquid is flowing from an inlet pipe 2 to an outlet pipe 3, describing with a pipe cranked upward and downward by 3m between the inlet pipe 2 and the outlet pipe 3, in a means to prevent gas 7 from accumulating at an upper part of the crank portion, a drawing pipe inlet 13 is arranged at the top of where the gas 7 is accumulated, and the inlet 13 is led therefrom to a negative pressure generating head 6 through a drawing pipe 12. The negative pressure generating head 6 is a resistor of a fluid flow, and a flow-receiving side of the head 6 is under positive pressure, and a back side of the flow-receiving side is under negative pressure. The negative pressure generating head 6 has an opening on its negative pressure side, and this results in a structure which makes the pressure inside the drawing pipe 12 negative. If liquid flow rates are the same, the larger a resistance area of the negative pressure generating head 6 is, the more suction power caused by negative pressure is increased (direct proportion). A negative pressure to suction gas from the drawing pipe inlet 13 is generated. In addition, when gas and liquid are compared, a fact that gas has a lower fluid resistance of the drawing pipe 12 makes the suction possible. The suction is possible when the suction power of the negative pressure generation head 6 generated by a flow rate of the liquid is beyond a pressure difference based on a height difference of 3m, but when the flow rate of the liquid is low, the pressure for suction becomes insufficient. For a required flow rate, more pressure difference which is generated by a flow rate resistance is necessary for gas having a higher ascent height of gas by buoyancy 4, and describing with a case when water is used as liquid, the pressure difference generated may not exceed a value which is produced by subtracting a height of water column more than water conveyance pressure and resistance of a pipe. A structure, in which discharging to outside of the system using the float type automatic air vent valve is not performed, and also in which gas is not accumulated, is constructed by an in-system delivery. In addition, this configuration avoids water leakage control, and inflow of outside air does not occur therein even when inside of the pipe is under negative pressure.

### Example 2

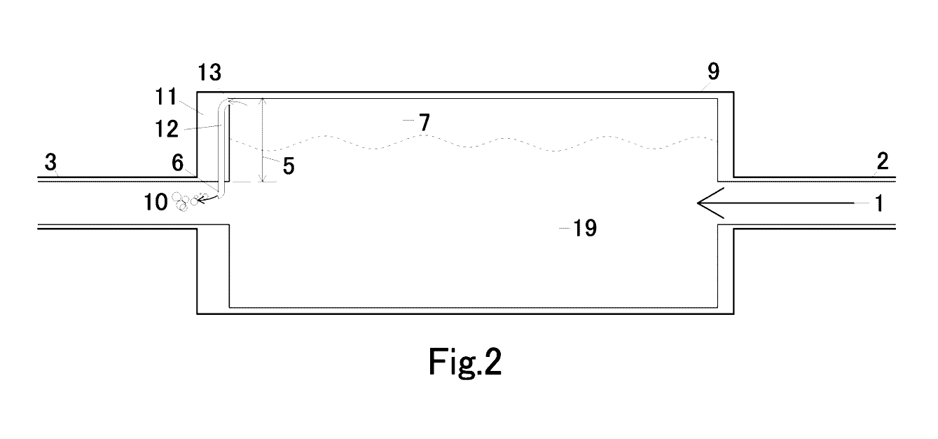

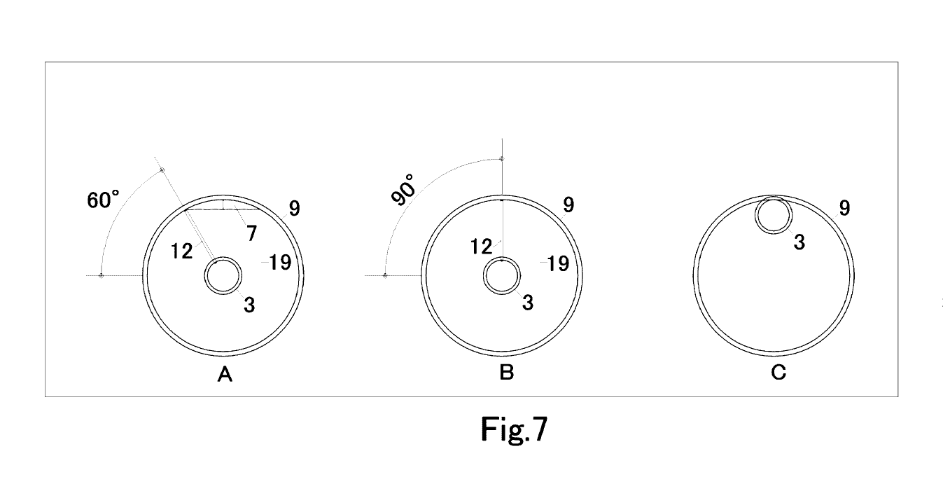

FIG. 2 is a transverse cross-sectional view. A liquid is flowing in an inflow direction of a liquid 1 from an inlet pipe 2 to an outlet pipe 3, and a tank or an equipment 9 is arranged between the inlet pipe 2 and the outlet pipe 3. Describing with a means to prevent gas 7 from accumulating at the upper part of the tank or the equipment 9, a drawing pipe inlet 13 is arranged at the top of where the gas 7 is accumulated, and the inlet 13 is led therefrom to a negative pressure generating head 6 through a drawing pipe 12. The negative pressure generating head 6 has a same structure with what is described in FIG. 1. A position where the negative pressure generating head 6 is arranged is a part of the outlet pipe 3 where flow rate is high, and the flow rate is usually the highest around a center portion of the pipe. A delivery power of the gas 7 is generated by a sum of a pressure difference generated by a flow rate difference because of a difference between a cross-sectional area of the tank or the equipment 9 and a cross-sectional area of the outlet pipe 3, and a suction power caused by negative pressure generated by the negative pressure generating head 6. The delivery of gas is done using an action that the gas 7 flows to the drawing pipe 12 earlier than liquid because of resistance occurring when the liquid moves from the tank or the equipment 9 to the outlet pipe 3. The delivery power of the gas 7 is sufficient provided the flow rate of the liquid is high, but when the flow rate of the liquid is low, the delivery power of the gas 7 becomes insufficient. The required flow rate is a flow rate proportional to a height of air accumulated 5. In addition, a position where the drawing pipe 12 is arranged is inside a side panel part 11, but the same effect is obtained even when the drawing pipe 12 is arranged independently at a liquid 19 side of the side panel part 11 or arranged along the side panel part 11. In addition, as shown in FIG. 1, it is possible to provide the drawing pipe 12 outside the side panel part 11. Thus, the delivery of the gas 7 inside the tank or the equipment 9 is performed with increased flow rate of the liquid. A setting of the flow rate of the liquid 19 is proportional to a difference between the cross-sectional area of the outlet pipe 3 and the cross-sectional area of the tank or the equipment 9. FIG. 7 is a side view. When the outlet pipe 3 is arranged at the top of the tank or the equipment 9 as shown in C of FIG. 7, the gas accumulation will not occur, but when the outlet pipe 3 is arranged at a center of the tank or the equipment 9 as shown in A and B of FIG. 7 and when the tank or the equipment 9 is a rotating body of which main axis is the inlet pipe 2 and the outlet pipe 3, the position of the outlet pipe 3 in C of FIG. 7 is unsatisfactory as an axis position of the rotating body. In addition, when the rotating body is stopping at a position by which the drawing pipe inlet 13 comes at the top of the tank or the equipment as in B of FIG. 7, the gas is suctioned and disappears, but when the rotating body is stopped such that the drawing pipe inlet 13 moves from the position shown in B of FIG. 7 to a position which is rotated 60 degrees in a circumferential direction, same amount of gas may be accumulated constantly. For example, by changing the rotation angle of the rotating body such that the drawing pipe inlet 13 comes to a different position, a proportion of gas and liquid may be varied easily. This is effective such as when gas and liquid is mixed by rotating motion of the tank or equipment 9 to make a moose-like product. This is impossible with the conventional float type automatic air vent valve, but technical elements of the present invention make this possible.

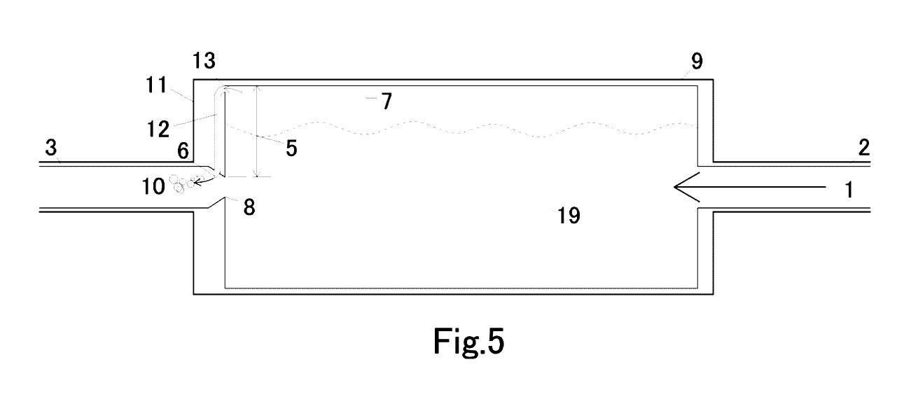

FIG. 5 is a transverse cross-sectional view. Configuration of FIG. 5 is what in which a throttle part 8 is provided to FIG. 2, and the throttle part 8 is equivalent to an orifice. The delivery power of the gas 7 is generated by a sum of a pressure difference generated by a flow rate difference because of a difference between the cross-sectional area of the tank or the equipment 9 and a cross-sectional area of the throttle part 8, and the suction power caused by the negative pressure generating head 6. This is a simple structure suitable when the height of air accumulated 5 and the flow rate are fixed.

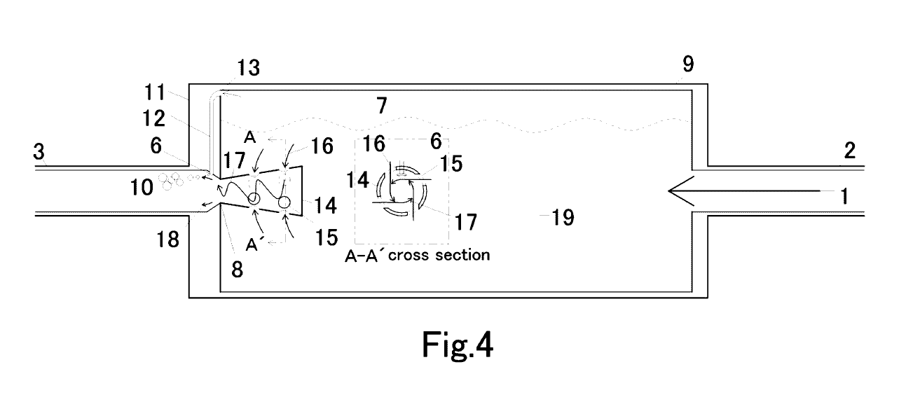

FIG. 4 is a transverse cross-sectional view, and illustrates a cross section A-A′ in the figure. The configuration of FIG. 4 is what in which a spiral rotation generating part 14 is provided to FIG. 5. The negative pressure generation head 6 has a same structure with what is described in FIG. 1. The spiral rotation generating part 14 and the throttle part 8 are arranged at a connecting part of the tank or the equipment 9 and the outlet pipe 3. The liquid 19 flows from an inflow direction 16 so as to merge into a liquid gathering direction by spiral rotation 17 by passing through inflow openings 15 provided on the spiral rotation generating part 14. As in the A-A′ cross-sectional view, each of the inflow openings 15 is eccentrically arranged in four directions on the spiral rotation generating part 14 respectively. Directions and numbers of the inflow openings 15 are increased or decreased depending on its respective diameters and/or viscosity of a fluid. In the transverse cross-sectional view of FIG. 4, four inflow openings 15 in two rows, eight in total are illustrated, but the inflow opening 15 may be one or plural to generate a rotating flow. With the fluid rotating spirally and accelerating toward the throttle part 8, and flowing toward a centrifugally spreading direction 18, a sufficient flow rate is generated even at an outer circumferential part around the negative pressure generating head 6 of the outlet pipe 3, and a power of negative pressure generated by the negative pressure generating head 6 increases as well. The delivery power of gas is generated by a sum of a pressure difference generated by a flow rate difference because of a difference between the cross-sectional area of the tank or the equipment 9 and the cross-sectional area of the throttle part 8, and the suction power caused by the negative pressure generating head 6. An effect of the spiral rotation generating part 14 is that turbulence from the tank or the equipment 9 to the outlet pipe 3 is prevented to lower the resistance such that the cross section of the throttle part 8 may be increased, and thus providing an advantage of allowing a flow rate resistance to be lowered. Depending on viscosity and/or a flow rate of the fluid, a straight configuration without the throttle part 8 is also possible. In addition, even when a flow volume is relatively small, a flow rate at the outer circumferential part which allows the negative pressure generating head 6 to effectively generate the negative pressure is obtained. Furthermore, since there is no movable part such as a valve, durability is significantly high.

### Example 3

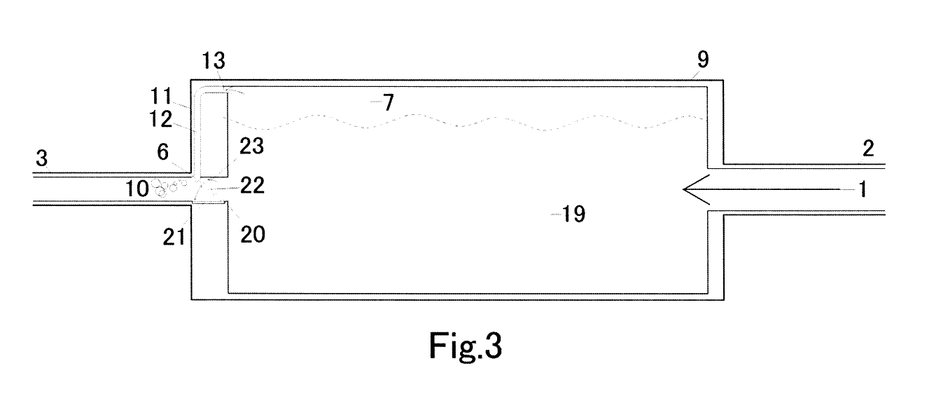

FIG. 3 is a transverse cross-sectional view. A liquid is flowing in an inflow direction of a liquid 1 from an inlet pipe 2 to an outlet pipe 3, and a tank or an equipment 9 is arranged between the inlet pipe 2 and the outlet pipe 3. Describing with a means to prevent a gas 7 from accumulating at an upper part of the tank or the equipment 9, a drawing pipe inlet 13 is arranged at the top of where the gas 7 is accumulated, and the inlet 13 is led to a negative pressure generating head 6 through the drawing pipe 12. The negative pressure generating head 6 has a same structure with what is described in FIG. 1. A valve (open position) 21 and a valve (closed position) 22 are an identical valve, showing respective positions. There are valves of a buoyant type, a gravity type and a spring type. When an axle pin 20 of a valve is arranged at a lower side of the outlet pipe 3 to provide a valve, it is to be functioned as a buoyant type. In addition, when the axle pin 20 of the valve is arranged at an upper side of the outlet pipe 3 to provide a valve, it is to be functioned as a gravity type. The gravity type makes use of the valve's own weight. When the valve is to be functioned by the spring force, the axle pin 20 of the valve may be attached in any angles such as upper and/or lower side of the outlet pipe 3 to close the valve. The position where the valve is arranged is at a connecting part of the tank or the equipment 9 and the outlet pipe 3, and it is closer to the tank or the equipment 9 than to the negative pressure generating head 6. The delivery power of gas is generated by a sum of a pressure difference generated by a flow rate difference because of a difference between a cross-sectional area of the tank or the equipment 9 and a cross-sectional area of the outlet pipe 3, a suction power caused by the negative pressure generating head 6, and a pressure difference based on a closing power of the valve, but the delivery power functions even if the negative pressure generating head 6 is not provided and only an opening of the drawing pipe 12 exists. In this case, the suction power caused by the negative pressure is generated by a sum of a delivery power because of the pressure difference generated by the flow rate difference because of the difference between the cross-sectional area of the tank or the equipment 9 and the cross-sectional area of the outlet pipe 3, and the pressure difference caused by the closing power of the valve. Describing the operation, the valve is closed by the buoyancy, the spring force or the gravity, but when a flow is generated to exert a force to open the valve, the valve gradually increases its position, and when the flow rate is high, the position becomes approximately fully opened. When compared with resistance of an orifice, the resistance increases proportional to the flow rate in the case of the orifice. In the case of the valve which opens and closes, since resistance of the valve portion corresponding to the position becomes approximately steady, it is possible to generate a constant set pressure difference caused by the buoyancy, the spring force or the gravity to allow the gas 7 to be delivered accurately.

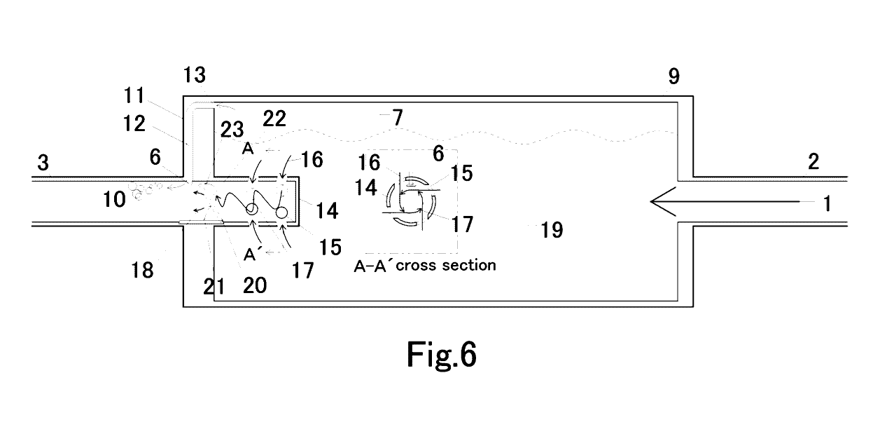

FIG. 6 is a transverse cross-sectional view, and illustrates a cross section A-A′ in the figure. The drawing pipe inlet 13 is arranged at the top of where the gas 7 is accumulated, and the inlet 13 is led to the negative pressure generating head 6 through the drawing pipe 12. The negative pressure generating head 6 has a same structure with what is described in FIG. 1. A spiral rotation generating part 14 and the valve are arranged on a connecting part of the tank or the equipment 9 and the outlet pipe 3. The valve (open position) 21 and the valve (closed position) 22 are an identical valve, showing respective positions. There are valves of the buoyant type, the gravity type and the spring type. When the axle pin 20 of the valve is arranged at the lower side of the outlet pipe 3 to provide a valve, it is to be functioned as the buoyant type. In addition, when the axle pin 20 of the valve is arranged at the upper side of the outlet pipe 3 to provide a valve, it is to be functioned as the gravity type. The gravity type makes use of the valve's own weight. When the valve is to be functioned by the spring force, the axle pin may be attached in any angles such as upper and/or lower side of the outlet pipe 3 to close the valve. A liquid 19 flows from the inflow direction 16 so as to merge into a liquid gathering direction by spiral rotation 17 by passing through inflow openings 15 provided on the spiral rotation generating part 14. As described in FIG. 4, combination of numbers of the inflow openings 15 depends on properties and/or usage of the liquid. As in A-A′ cross-sectional view, each of the inflow openings 15 is eccentrically arranged in four directions on the spiral rotation generating part 14 respectively. Directions and numbers of the inflow openings 15 are increased or decreased depending on its respective diameters and/or viscosity of a fluid. The delivery power of the gas 7 is generated by the sum of the pressure difference generated by the flow rate difference because of the difference between the cross-sectional area of the tank or the equipment 9 and the cross-sectional area of the outlet pipe 3, and the suction power caused by the negative pressure generating head 6, and the pressure difference based on the closing power of the valve. The delivery power functions even if the negative pressure generating head 6 is not provided and only the opening of the drawing pipe 12 exists. In this case, the delivery power of the gas 7 is generated by a sum of the pressure difference generated by the flow rate difference because of the difference between the cross-sectional area of the tank or the equipment 9 and a cross-sectional area of the outlet pipe 3, and the pressure difference based on the closing power of the valve. Describing the operation, the valve is closed by the buoyancy, the spring force or the gravity, but when a flow is generated to exert a force to open the valve, the valve gradually increases its position, and when the flow rate is high, the position becomes approximately fully opened. When compared with resistance by the orifice, the resistance increases proportional to the flow rate in the case of the orifice. In the case of the valve, when it is opened fully, the resistance by the valve portion disappears and only the resistance of the pipe remains, resulting in a steady resistance of the valve corresponding to the position. Thereby, it is possible to generate a constant pressure difference (a pressure inside the tank or the equipment 9 and a pressure of the outlet pipe 3 where the negative pressure generating head 6 exists) by the buoyancy or the spring force even when the flow rate is low, and approximately steady resistance is created until the valve is fully opened to allow the gas 7 to be delivered accurately. The fluid serves to hold the valve (open position) 21 down with a centrifugal force of the fluid by rotating spirally and flowing in a centrifugally spreading direction 18. If flow volume is equivalent, and when the spiral rotation generating part 14 exists, a force of water flow hit on the valve opens the valve stronger by an amount of the centrifugal force. Since the centrifugal force which opens the valve becomes the force to hold the valve down, the valve fully opens stably with less flow volume than in the case of FIG. 3. Even if an initial pressure, when the flow volume is small, is the same as in the case of FIG. 3, it is possible to lower increase of the resistance by the flow rate during the valve is fully opened. In addition, even with the small flow volume, a sufficient flow rate is generated as well at an outer circumferential part around the negative pressure generating head 6 of the outlet pipe 3, and a power of negative pressure generated by the negative pressure generating head 6 increases as well. A resistance loss may be lowered with any flow volumes from small to large to allow an efficient delivery of gas by suction. For example, in a case of air in a water supply, since water decay occurs if the gas 7 is accumulated, it is desirable to lower the resistance loss to allow functioning even with the small low volume. In addition, since pressure of running water changes depending on each local regions and time zones, and water pressure and/or flow volume changes also depending on each diameters of respective water meters and/or amount used by surroundings, it is possible to reserve freshness of water in a case when the tank and/or the equipment is connected, by avoiding air accumulation, even when flow volume is small.

### Example 4

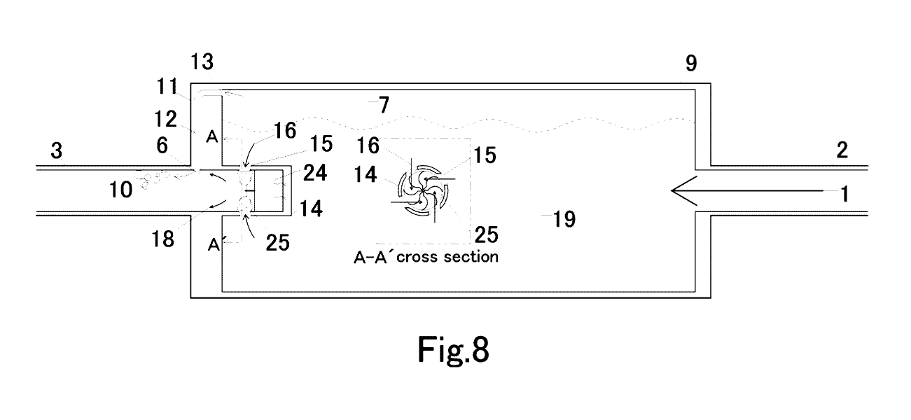

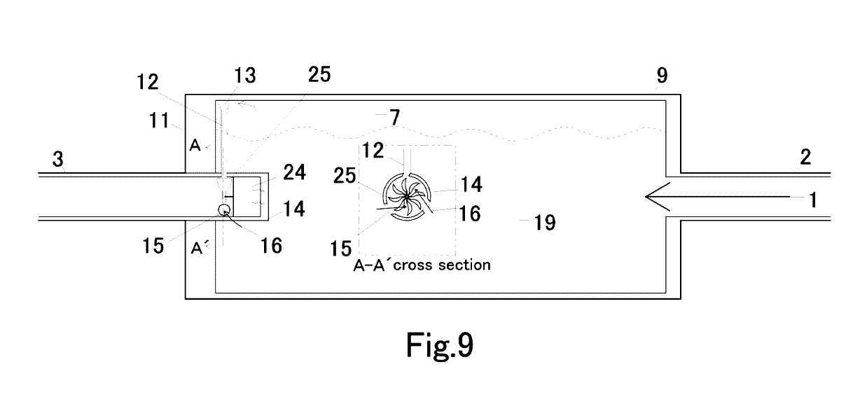

FIG. 8 is a transverse cross-sectional view, and illustrates a cross section A-A′ in the figure. When a liquid 1 flows in an inflow direction from an inlet pipe 2 to a tank or an equipment 9 and to an outlet pipe 3, if a water surface height inside the tank or the equipment 9 is higher than the outlet pipe 3, gas or air accumulation occurs. The mechanism which eliminates the gas or air accumulation is a mechanism in which a drawing pipe inlet 13 at the top of the tank or the equipment 9, a drawing pipe 12 and a negative pressure generating head 6 are provided, and a pressure difference between the tank or the equipment 9 and the outlet pipe 3 is generated to discharge a gas 7 to the outlet pipe 3. A spiral rotation generating part 14 is provided between the tank or the equipment 9 and the outlet pipe 3. In the spiral rotation generating part 14, each of inflow openings 15 illustrated in A-A′ cross-section is arranged eccentrically from a centerline in four directions, the fluid in an inflow direction 16 enters into a water wheel 25, and electric power generation is performed at an electric power generating part 24 connected to the water wheel 25. A water flow which has passed through the water wheel 25 has a spiral rotation generated therein and flows along with centrifugal force in a direction of the outlet pipe 3. A pressure difference is a pressure difference generated from a flow rate difference because of a difference between a cross-sectional area of the tank or the equipment 9 and a cross-sectional area of the outlet pipe 3 (Bernoulli theorem), and also, a pressure difference generated by the negative pressure generating head 6, but a pressure difference caused by a resistance of the water wheel between the tank or the equipment 9 and the outlet pipe is generated. If a flow volume increases, a rotational resistance of the water wheel increases, and electric power generation energy of the electric power generating part 24 increases. With the flow volume and the flow rate, an energy transference which will be replaced with electrical energy is generated, and a pressure loss for the electric power generation may be obtained by the water flow. Thereby, the pressure difference which eliminates the gas accumulation is generated. With respect to a difference with FIGS. 3, 4 and 5, originally, a pressure difference is resistance loss and energy loss, but by replacing the pressure difference with electricity, an energy-saving electric power generation is achieved in parallel with discharging of gas. There are various types of electric power generation by the water flow, and they are characteristic in that the water flow is used for eliminating the air accumulation. The generated electric power may be used for storage of electricity and/or supplemental charging for natural wastage of a storage battery and/or as a power source of a control and condition display. In addition, the negative pressure generating head 6 generates a negative pressure by a pressure difference between a plane which the fluid hits and a plane opposite thereto, and the larger the plane which the fluid hits, the more a negative pressure generating power increases. At the same time, since the resistance loss of pipe lines increase, when the pressure difference other than that generated by the negative pressure generating head 6 is large, the negative pressure generating head 6 may not be provided, or the plane which the fluid hits may be made smaller to lower the resistance. That is to say, since a power to transfer the gas 7 to the outlet pipe 3 may be obtained when the fluid resistance of the water wheel is sufficiently large, it is possible not to provide the negative pressure generating head 6 and to provide an opening of the drawing pipe 12 only. As similarly applied to FIGS. 4 and 6, in the spiral rotation generating part 14, the flow rate increases abruptly and turbulence occurs when the liquid is charged into the outlet pipe 3 from the tank or the equipment 9. The water wheel has an effect to lower a resistance because of turbulence to rotate the water wheel effectively. FIG. 9 is a transverse cross-sectional view, and illustrates a cross section A-A′ in the figure. In FIG. 9, the negative pressure generating head 6 of FIG. 8 is removed, and the position where the drawing pipe 2 is arranged is changed. The drawing pipe inlet 13 at the top of the tank or the equipment 9 and the drawing pipe 12 are provided, and the drawing pipe 12 is led to the upper part of the spiral rotation generating part 4. This configuration generates a pressure difference between the tank or the equipment 9 and the outlet pipe 3 to discharge the gas 7 to the outlet pipe 3. The spiral rotation generating part 14 is provided between the tank or the equipment 9 and the outlet pipe 3. On the spiral rotation generating part 14, inflow openings 15 illustrated in A-A′ cross section are arranged eccentrically from the center line in lower-side two directions, and the fluid in the inflow direction 16 enters into the water wheel 25 and electric power generation is performed at the electric power generating part 24 connected to the water wheel 25. In addition, a pump may be used instead of the electric power generating part. A water flow which has passed through the water wheel 25 has a spiral rotation generated therein and flows along with centrifugal force in a direction of the outlet pipe 3. A process, in which the gas 7 is suctioned from the drawing pipe inlet 13 through the drawing pipe 12 led to the upper side of the spiral rotation generating part 14, is generated by an operation of the fluid in the inflow direction 16 allowing the water wheel 25 to rotate to make a flow volume of each of the inflow openings 15 and a flow volume of the drawing pipe 12 the same by wings of the water wheel 25. In addition, when the gas accumulation is eliminated, the liquid generates a spiral rotation in a flow direction 3. Differences with the configuration of FIG. 8 are differences concerning suction power of the water wheel and the position where the drawing pipe 12 is arranged, and when compared with the case in FIG. 8 where the negative pressure generating head 6 is not provided, components are the same. In addition, if the position to attach the outlet pipe 3 is made closer to the upper part of the tank or the equipment 9, the drawing pipe 12 may be made shorter, and discharging of the gas 7 becomes possible only with the drawing pipe inlet 13. This is a configuration in a case where the gas accumulation is generated.

### INDUSTRIAL APPLICABILITY

When the present invention is used for piping of a water supply, water storage becomes possible and the stored water may be used in case of cuts in water supply. Alternatively, when the present invention is used for piping of hot and cold water, since the piping may be lifted up and down, there are big advantages that discharging of gas is allowed in a machine room and corrosion of piping is avoided. The above advantages are similarly applied in cases for cooling medium and/or oil. The present invention is targeted also to factory equipment lines of food, chemicals and/or dangerous materials and nuclear power equipment, and thus, utilizable range is wide.

### EXPLANATION OF NUMERICAL CHARACTERS

1. inflow direction of a liquid
2. inlet pipe
3. outlet pipe
4. ascent height of gas by buoyancy
5. height of air accumulated
6. negative pressure generating head
7. air
8. throttle part
9. tank or equipment
10. air bubbles
11. side panel part
12. drawing pipe
13. drawing pipe inlet
14. spiral rotation generating part
15. inflow openings
16. inflow direction
17. liquid gathering direction by spiral rotation
18. centrifugally spreading direction
19. liquid
20. axle pin of a valve
21. valve (open position)
22. valve (closed position)
23. flow during a small flow volume
24. electric power generating part
25. water wheel

1. An apparatus for preventing gas accumulation characterized in that a means for delivering gas between a tank or an equipment and an outlet pipe is provided, wherein the means is configured by a drawing pipe inlet at the top of the tank or the equipment where gas is accumulated, a drawing pipe which delivers gas and a negative pressure generating head which discharges gas to the outlet pipe.

2. An apparatus for preventing gas accumulation characterized in that the apparatus is configured by a drawing pipe inlet at the top of a tank or an equipment where gas is accumulated, a drawing pipe which delivers gas, a negative pressure generating head which discharges gas to an outlet pipe, and a spiral rotation generating part for liquid, wherein power to deliver gas between the tank or the equipment and the outlet pipe is generated.

3. An apparatus for preventing gas accumulation characterized in that the apparatus is configured by a drawing pipe inlet at the top of a tank or an equipment where gas is accumulated, a drawing pipe connected to an outlet pipe to deliver gas, and a water wheel at a spiral rotation generating part for liquid, wherein power to deliver gas between the tank or the equipment and the outlet pipe is generated.

4. An apparatus for preventing gas accumulation characterized in that the apparatus is configured by a drawing pipe inlet at the top of a tank or an equipment where gas is accumulated, a drawing pipe which delivers gas, a negative pressure generating head which discharges gas to an outlet pipe, and a valve of a buoyant type, a gravity type or a spring type, wherein power to deliver gas between the tank or the equipment and the outlet pipe is generated.

5. An apparatus for preventing gas accumulation characterized in that the apparatus is configured by a drawing pipe inlet at the top of a tank or an equipment where gas is accumulated, a drawing pipe which delivers gas, a negative pressure generating head which discharges gas to an outlet pipe, a water wheel at a spiral rotation generating part for liquid and an electric power generating part or a pump, wherein power to deliver gas between the tank or the equipment and the outlet pipe is generated.

6. An apparatus for preventing gas accumulation characterized in that the apparatus is configured by a drawing pipe inlet at the top of a tank or an equipment where gas is accumulated, a drawing pipe which delivers gas, a negative pressure generating head which discharges gas to an outlet pipe and a throttle part at a spiral rotation generating part for liquid, wherein power to deliver gas between the tank or the equipment and the outlet pipe is generated.

7. An apparatus for preventing gas accumulation characterized in that the apparatus is configured by a drawing pipe inlet at the top of a tank or an equipment where gas is accumulated, a drawing pipe which delivers gas, a negative pressure generating head which discharges gas to an outlet pipe and a throttle part, wherein power to deliver gas between the tank or the equipment and the outlet pipe is generated.

8. An apparatus for preventing gas accumulation characterized in that the apparatus is configured by a drawing pipe inlet at the top of a tank or an equipment where gas is accumulated, a drawing pipe which delivers gas, a negative pressure generating head which discharges gas to an outlet pipe, a valve of a buoyant type, a gravity type or a spring type and a spiral rotation generating part for liquid, wherein power to deliver gas between the tank or the equipment and the outlet pipe is generated.
